(19) United States
(12) Patent Application Publication
(10) Pub. No.: US 2009/0223951 A1
(43) Pub. Date: Sep. 10, 2009

(54) Constructs and Methods for Heating a Liquid in a Microwave Oven

(76) Inventors: Laurence M.C. Lai, Mississauga (CA); Michael J. Shaw, Thornhill (CA)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/395,868

(22) Filed: Mar. 2, 2009

Related U.S. Application Data
(60) Provisional application No. 61/068,185, filed on Mar. 4, 2008.

(51) Int. Cl. H05B 6/80

(52) U.S. Cl. 219/729

(57) ABSTRACT

A method of promoting uniform heating of a liquid in a microwave oven, comprises providing a container including an interior space for receiving a liquid, the liquid within the interior space having an uppermost portion and a lowermost portion, providing a microwave energy shielding element for being substantially laterally aligned with the uppermost portion of liquid, and exposing the liquid in the container to microwave energy. The microwave energy shielding element reduces the transmission of microwave energy to the uppermost portion of liquid in the container, which is prone to overheating relative to the lowermost portion.

### CROSS-REFERENCE TO RELATED APPLICATION

This application claims the benefit of U.S. Provisional Application No. 61/068,185, filed Mar. 4, 2008, which is incorporated by reference herein in its entirety.

### TECHNICAL FIELD

The present disclosure relates to various blanks, constructs, and methods for heating a food item, and particularly relates to various blanks, constructs, and methods for heating a food item in a microwave oven.

### BACKGROUND

Microwave ovens often are used as a convenient means to thaw, heat, or reheat beverages, soups, and other liquid and semi-liquid food items (collectively referred to herein as “liquids”). However, such items are prone to uneven heating by microwave energy. In particular, the food item often tends to be overheated at its periphery and upper surface and underheated at its center and bottom surface. Thus, there is a need for a construct that promotes even heating of a liquid food item in a microwave oven.

### SUMMARY

This disclosure is generally related to various methods and constructs (e.g., sleeves, sheaths, containers, etc.) for promoting uniform heating of a liquid in a microwave oven. The various methods and constructs generally employ one or more microwave energy shielding elements that alter the rate of heating of at least a portion of the liquid in a microwave oven. As a result, the food item may be heated more uniformly, top to bottom and/or center to periphery. In some instances, the food item even may be suitable for consumption upon removal from the microwave oven without stirring. The methods and constructs may be suitable for use with numerous food items, including those that are formed partially, substantially, or entirely from a liquid.

One exemplary method of promoting uniform heating of a liquid in a microwave oven comprises providing a container including a base and an upstanding wall that define an interior space for receiving a liquid. The liquid within the interior space has an uppermost portion and a lowermost portion, with the uppermost portion of liquid being prone to overheating relative to the lowermost portion. A microwave energy shielding element is substantially laterally aligned with the uppermost portion of liquid and the liquid in the container is exposed to microwave energy. In accordance with the exemplary method, the microwave energy shielding element reduces the transmission of microwave energy to the uppermost portion of liquid in the container, thereby substantially mitigating the overheating of the uppermost portion of liquid relative to the lowermost portion of liquid.

In one variation, providing the microwave energy shielding element comprises determining an anticipated top liquid level for the container, and joining the microwave energy shielding element to the wall of the container such that the microwave energy shielding element substantially overlaps the anticipated top liquid level.

In another variation, providing the microwave energy shielding element comprises determining an anticipated top liquid level for the container, mounting the microwave energy shielding element to a sheath for enwrapping the container such that the microwave energy shielding element substantially overlaps the anticipated top liquid level of the container, and enwrapping the container with the sheath.

In one exemplary embodiment, a container for providing even heating of a liquid food item in a microwave oven comprises a base and an upstanding wall that define an interior space for receiving a liquid. The liquid within the interior space has an uppermost portion adjacent to an upper portion of the wall and a lowermost portion adjacent to a lower portion of the wall. A microwave energy shielding element overlies the upper portion of the wall. The microwave energy shielding element is operative for reducing the transmission of microwave energy to the uppermost portion of liquid in the container. The microwave energy shielding element may include one or more apertures that allow the passage of microwave energy therethrough. The lower portion of the wall is at least partially transparent to microwave energy.

In another exemplary embodiment, a construct (e.g., a sheath) for promoting even heating of a liquid food item in a microwave oven comprises a main panel for at least temporarily enwrapping a wall of a conventional container. The main panel includes a microwave energy shielding element positioned to overlap with the anticipated top level of the liquid in the container. The construct also may include a pair of locking projections connected to the main panel. The locking projections are adapted to engage one another to maintain the main panel in a proximate relationship with the wall of the container.

The construct further may include a pair of end panels connected to the main panel. The end panels may be adapted to be brought into a substantially facing relationship with one another when the locking projections are engaged with one another, and in some embodiments, may serve as handles for the construct and container. When the construct is secured to the container, an upper edge of the microwave energy shielding element may be substantially parallel to an upper edge of the wall of the container, and a lower edge of the microwave energy shielding element may be substantially parallel to a lower edge of the wall of the container.

Other features, aspects, and embodiments will be apparent from the following description and accompanying figures.

### BRIEF DESCRIPTION OF THE DRAWINGS

The description refers to the accompanying drawings, some of which are schematic, in which like reference characters refer to like parts throughout the several views, and in which:

FIG. 1A is a schematic perspective view of an exemplary container for heating a food item in a microwave oven;

FIG. 1B schematically depicts an exemplary blank that may be used to form the wall of the container of FIG. 1A;

FIG. 2A schematically depicts a microwave heating construct for heating a food item in a microwave oven, in an unerected form;

FIG. 2B schematically depicts the construct of FIG. 2A with a conventional container; and

FIG. 2C schematically depicts the microwave heating construct in an erected form enwrapping the container.

### DESCRIPTION

The present invention may be illustrated further by referring to the figures. For purposes of simplicity, like numerals may be used to describe like features. It will be understood that where a plurality of similar features are depicted, not all of such features necessarily are labeled on each figure. It also will be understood that various components used to form the blanks and constructs of the present invention may be interchanged. Thus, while only certain combinations are illustrated herein, numerous other combinations and configurations are contemplated hereby.

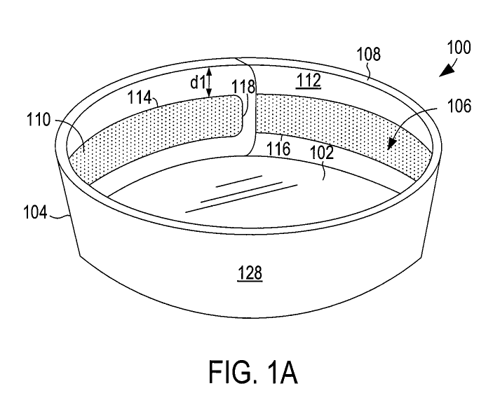

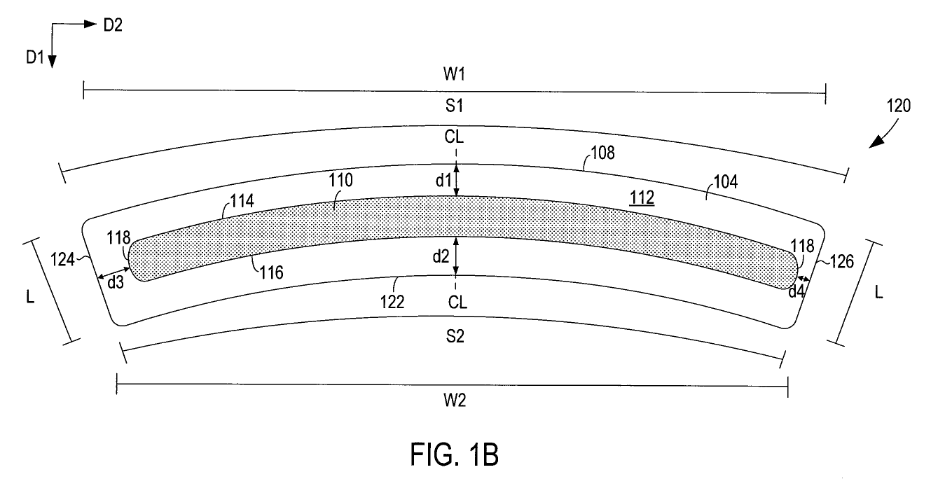

FIG. 1A schematically depicts an exemplary construct 100, for example, a container, for heating a food item in a microwave oven. The container 100 includes a base 102 and a substantially upstanding wall 104 that collectively define an interior space 106 for receiving a liquid or semi-liquid food item (collectively referred to herein as “liquid” food items), for example, a beverage, soup, stew, or sauce. The uppermost portion of the wall 104 generally comprises an edge or rim 108 that defines an opening for the container 100.

A microwave energy interactive element 110, in this example, a microwave energy shielding element (“shielding element”), is mounted to an interior side 112 of the wall 104. In the illustrated example, the shielding element 110 comprises a circumferential “band” of microwave energy interactive material that includes an upper edge 114, a lower edge 116, and a pair of lateral ends 118 (FIG. 1B) spaced from one another, such that the shielding element 110 extends only partially around the circumference (or perimeter) of the wall 104. However, in other embodiments, the shielding element 110 may extend continuously around the circumference (or perimeter) of the container wall 104 (or walls).

If desired, the ends 118 of the shielding element 110 may be somewhat rounded in shape and/or may have somewhat rounded corners. While not wishing to be bound by theory, is believed that providing a rounded shape in this manner serves to reduce the formation of undesirable fringe fields that might otherwise cause overheating or charring of the construct.

In this example, the upper edge 114 of the shielding element 110 is spaced from the rim 108 a distance d1. Although the exact position of the shielding element 110 may vary for each heating application, the shielding element is generally positioned on the wall 104 of the container to be adjacent to (or “overlapping”) the anticipated top (i.e., uppermost or maximum) liquid level for the container. In this example, the shielding element 110 is generally centered between the rim 108 and the base 102 of the container 100. However, in other embodiments, the shielding element 110 may overlie only an upper portion or lower portion of the container.

When the container 100 is used to heat a food item in a microwave oven, the microwave energy shielding element 110 generally reduces or prevents transmission of microwave energy through the walls 104 to the interior space adjacent to the shielding element 110, for example, to the medial and/or upper portion of liquid in the container in lateral alignment with the shielding element 110. At the same time, microwave energy can pass freely through the various unshielded areas, including the areas of the walls 104 not covered by the shielding element 110, the open “top” of the container 100, and the base 102. Depending on the particular food item being heated, the microwave energy shielded areas and unshielded areas can be arranged to control the rate of heating of particular areas of the food item prone to overheating or underheating. In this manner, a food item heated in the various constructs of the invention generally have a better, and more even, temperature profile between the top and bottom surfaces of the food item, and between the edge and center of the food item.

If additional heating is needed, the container 100 may include one or more apertures (not shown) within and/or circumscribed by the microwave energy shielding element. Such apertures may have any shape or size needed, as will be discussed further below.

Further, it is contemplated that one or more microwave energy interactive elements additionally or alternatively may overlie and/or may be joined to an exterior side of the wall 104, the interior side of the base 102, the exterior side of the base 102, or any combination thereof.

FIG. 1B schematically depicts an exemplary construct or blank 120 that may be used to form the wall 104 of the container 100 of FIG. 1A or numerous other containers or other constructs contemplated by the disclosure. The blank 120 may be characterized as having various dimensions, for example, lengths and widths. For purposes of reference only, some of such dimensions may be described with reference to a first dimension, extending in a first direction, for example, a longitudinal direction, D1, and a second dimension, extending in a second direction, for example, a transverse direction, D2. It will be understood that such designations are made only for convenience and do not necessarily refer to or limit the manner in which the construct is manufactured or erected. Each of the various dimensions may vary in relative and absolute value, depending on where the dimension is measured on the blank 120. The blank 120 may be substantially symmetrical along a longitudinal centerline CL.

As shown schematically in FIG. 1B, the blank 120 includes a main panel 104 (or wall panel 104) having a generally curved trapezoidal shape defined by a plurality of peripheral edges 108, 122, 124, 126 respectively joined to one another to define rounded corners. Edges 108, 122 are generally curved or arcuate and extend generally in the second direction, substantially equidistant from one another. Edges 124, 126 are substantially linear and extend generally in the first direction oblique to the longitudinal centerline CL, with the edges 124, 126 extending convergently from arcuate edge 108 towards arcuate edge 122. Each edge may vary in dimension, and in one example, the respective lengths, L, of edges 124, 126 may be approximately equal. In contrast, arcuate edges 108, 122 may be characterized as having respective arc lengths S1, S2, with S1 being greater than S2, such that the blank 120 has an overall corner to corner dimension that varies between widths W1, W2.

It is noted that the blank 120 illustrated schematically in FIG. 1B has somewhat rounded corners and, as a result, the precise boundaries between two abutting edges may be difficult to discern. Thus, while the various edges are described as having measurable lengths, it will be understood that the precise dimensions may vary depending on the manner in which the particular edge is measured.

Still viewing FIG. 1B, a microwave energy shielding element 110 overlies and may be joined to a first side 112 of the main panel 104. The shielding element 110 may be somewhat obround in shape (i.e., it may substantially resemble two semicircles connected by parallel lines tangent to their endpoints), except that it has a slight curvature generally tracking or corresponding to that of arcuate edges 108, 122 and therefore, may be referred to as “arcuate obround”, “curved obround”, or simply “arcuate” in shape.

If desired, the shape of the microwave energy shielding element 110 generally may correspond to or “track” the overall shape of the main panel 104, such that the edges 114, 116 of the shielding element 110 have substantially the same radius of curvature as the respective edges 108, 122 of the main panel 104, and/or such that edge 114 of the shielding element 110 is substantially equidistant from edge 108 of the main panel 102, and/or such that edge 116 of the shielding element 110 is substantially equidistant from the edge 122 of the main panel 102.

A second side 128 of the main panel 104 (hidden from view in FIG. 1B, best seen in FIG. 1A) opposite the first side 112 also may have one or more microwave energy interactive elements if desired. The remaining area of the blank 120 is generally transparent to microwave energy.

In this example, the shielding element 110 is positioned a distance d1 from edge 108, a distance d2 from edge 122, a distance d3 from edge 124, and a distance d4 from edge 126. The various distances d1, d2, d3, d4 are selected to provide the desired degree of shielding in a particular area, to reduce charring associated with the formation of fringe fields during exposure to microwave energy, and in the case of distances d3, d4, to prevent arcing between the lateral ends 118 of the shielding element 110 when the blank 120 is formed into a construct. In this example, d3 is greater than d4, and d1 and d2 are approximately equal. However, other configurations are contemplated by the disclosure.

By way of illustration and not limitation, in each of various examples, d1 independently may be from about 0.1 to about 10 cm, from about 0.3 to about 5 cm, from about 0.5 to about 3 cm, or from about 1 to about 2.5 cm, for example, about 1.9 cm; d2 independently may be from about 0.1 to about 10 cm, from about 0.3 to about 5 cm, from about 0.5 to about 3 cm, or from about 1 to about 2.5 cm, for example, about 2.0 cm; d3 independently may be from about 0.1 to about 10 cm, from about 0.3 to about 5 cm, from about 0.5 to about 3 cm, or from about 1 to about 2.5 cm, for example, about 1.8 cm; and d4 independently may be from about 0.1 to about 10 cm, from about 0.3 to about 5 cm, from about 0.5 to about 3 cm, or from about 1 to about 2.5 cm, for example, about 0.80 cm.

Further, in each of various examples, S1 independently may be from about 20 to about 100 cm, from about 30 to about 70 cm, or from about 35 to about 50, for example, about 42 cm; S2 independently may be from about 15 to about 100 cm, from about 20 to about 70 cm, or from about 25 to about 50, for example, about 38 cm; W1 independently may be from about 20 to about 100 cm, from about 30 to about 70 cm, or from about 35 to about 50, for example, about 41 cm; W2 independently may be from about 15 to about 100 cm, from about 20 to about 70 cm, or from about 30 to about 50, for example, about 37 cm; and L independently may be from about 1 to about 30 cm, from about 2 to about 15 cm, or from about 5 to about 10 cm, for example, about 6.2 cm. However, other distances, dimensions, and configurations are contemplated hereby.

To prepare the blank 120 for use in the container 100, edges 124, 126 may be brought towards each other to form a ring-like structure (not shown in isolation). The ends of the blank 120 then may be overlapped as needed to provide a sufficient joining area, while typically, but optionally, maintaining a desired distance or gap between the corresponding ends of the shielding element 110. The precise gap may vary for each application. In each of various examples, the gap may be at least about 10 mm, at least about 12 mm, at least about 14 mm, at least about 16 mm, from about 10 mm to about 20 mm, or from about 11 mm to about 15 mm, for example, about 13 mm. However, other gap dimensions are contemplated hereby.

The overlapped ends of the blank 120 then may be joined using any suitable chemical, thermal, or mechanical means to form a tubular structure or construct that may be joined to a base panel (e.g. joined in a conventional manner to the periphery of a conventional circular base panel, or the like) to form a container, for example, as shown in FIG. 1A. The tubular structure may be substantially uniform in diameter or may taper in diameter (e.g., may be frustoconical in shape), depending on the type of container to be formed.

According to another aspect of the disclosure, the tubular structure may be used as a sheath or sleeve that encircles all or a portion of the wall(s) of a conventional container, for example, a paper cup or bowl (not shown). The sleeve may be used as described above to reduce the rate of heating in the shielded areas, thereby providing a more even temperature profile throughout the food item, for example, a beverage, soup, sauce, or other suitable food item. Thus, in some instances, a cup of coffee that would otherwise need to be stirred or allowed to cool to achieve a desired consumption temperature may be consumed immediately after heating without the need for stirring and/or cooling.

Numerous variations are contemplated. In one embodiment, the microwave sheath may be provided to the user in a pre-constructed form that may be slipped over the wall of the container. The sheath and/or container may be provided with markings or other indicia that ensure proper positioning along the container wall. The sheath may be packaged in a flattened configuration and unfolded prior to use or may be provided in an open, erected configuration. Alternatively, the sheath may be provided in a flattened, open configuration, provided with a tab and slot (or other fastening means) for securing the sheath to the container. If desired, the sheath may be formed at least partially from a thermal insulating material, for example, a corrugated material, to enable the user to handle the container more comfortably.

It will be understood that any of such sheaths, in addition to any of the other constructs contemplated by the disclosure, may be adjustable, such that the user can position the sleeve or sheath as needed to align the shielding element with the upper portion of the liquid to be heated, or may be “self-locating”, that is, designed to engage the container at a specific location to ensure proper alignment of the shielding element and sufficiently intimate contact with the wall of the container. In some embodiments, such self-locating constructs may have a specific shape and/or dimensions that facilitate proper positioning on the container. For example, the sleeve may be dimensioned so that the user can slide the sleeve onto the container (e.g., from the base upward) only up to a specific point where the outer diameter of the container is equal to the inner diameter of the sleeve. Further, where the container has a tapered profile, the sleeve may have a similar profile, so that when the proper position is reached, the sleeve is in intimate contact with the wall of the container.

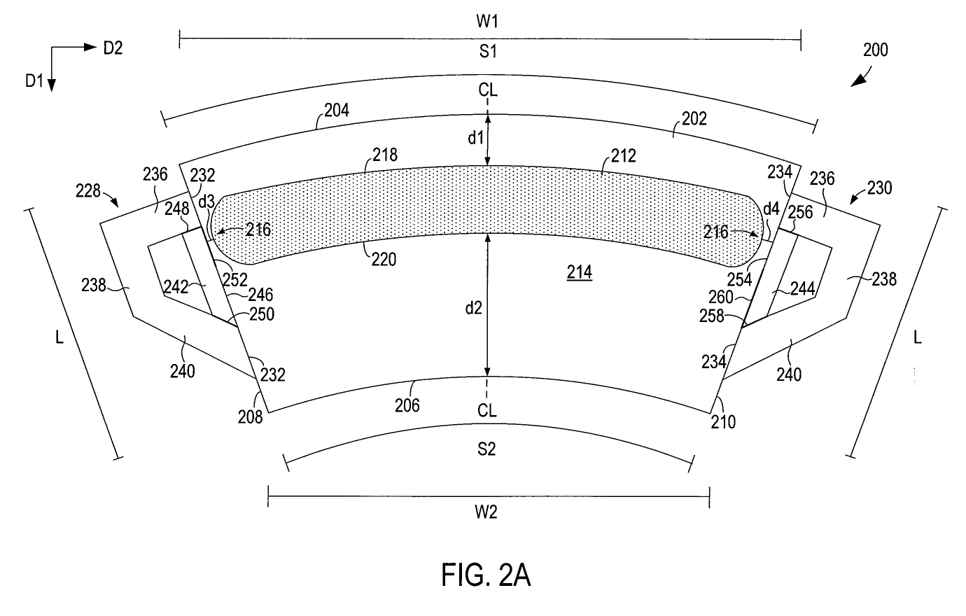

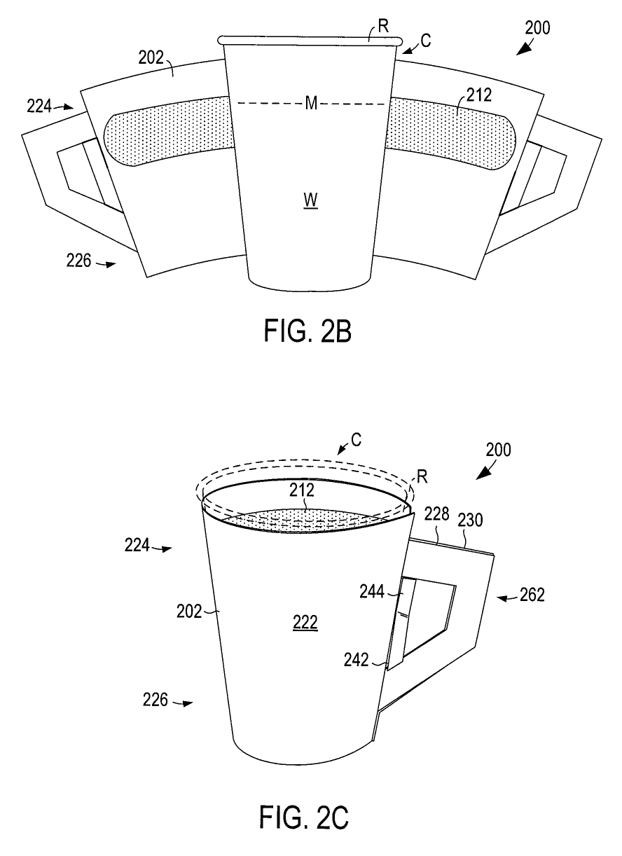

FIGS. 2A-2C schematically illustrate another exemplary construct 200 for heating a food item in a microwave oven. The construct 200 may be similar to the blank 120 of FIG. 1B, except for variations noted and variations that will be apparent to those of skill in the art. In FIG. 2A, the construct 200 is shown in an open, substantially flat or planar configuration (also referred to as a “blank”). In FIG. 2C, the construct 200 is shown with a conventional container C, in this example, a cup, prior to use. In FIG. 2C, the construct 200 is shown in an erected configuration wrapped around the container (shown schematically with dashed lines).

Viewing FIG. 2A, the construct 200 generally includes a plurality of panels joined along fold lines or other lines of disruption, for example, score lines. Each panel 200 may be characterized in its flattened form as having various dimensions, for example, lengths and widths. For purposes of reference only, some of such dimensions may be described with reference to a first dimension, extending in a first direction, for example, a longitudinal direction, D1, and a second dimension, extending in a second direction, for example, a transverse direction, D2. It will be understood that such designations are made only for convenience and do not necessarily refer to or limit the manner in which the construct is manufactured or erected. Each of the various dimensions may vary in relative and absolute value, depending on where the dimension is measured on the construct 200. Portions of the construct 200 may be substantially symmetrical along a longitudinal centerline CL.

As shown schematically in FIG. 2A, the flattened construct or blank 200 includes a main panel 202 including a plurality of peripheral edges 204, 206, 208, 210 defining a generally curved trapezoidal shape, such that the main panel 202 is suitable for enwrapping the wall W of a tapered container C (e.g., a frustoconical cup) (FIG. 2B). Edges 204, 206 are generally curved or arcuate and extend generally in the second direction, substantially equidistant from one another. Edges 208, 210 are substantially linear and extend generally in the first direction oblique to the longitudinal centerline CL. Each edge may vary in dimension, and in one example, the respective lengths, L, of edges 208, 210 may be approximately equal. In contrast, arcuate edges 204, 206 may be characterized as having respective arc lengths S1, S2, with S1 being greater than S2, such that the blank 200 has an overall corner to corner dimension that decreases from width W1 to W2.

Still viewing FIG. 2A, a microwave energy shielding element 212 overlies and may be joined to a first side 214 of the main panel 202. The shielding element 212 may be generally curved and/or obround in shape with rounded corners and/or lateral ends 216, and generally may correspond to or track the overall shape of the main panel 202, such that the upper and lower edges 218, 220 of the shielding element 212 have substantially the same radius of curvature as the respective proximate edges 204, 206 of the main panel 202, and/or such that edge 218 of the shielding element 212 is substantially equidistant from edge 204 of the main panel 102, and/or such that edge 220 of the shielding element 212 is substantially equidistant from the edge 206 of the main panel 202.

A second side 222 of the main panel 202 (hidden from view in FIG. 2A, best seen in FIG. 2C) opposite the first side 214 also may have one or more microwave energy interactive elements if desired. The remaining portions of the main panel 202 are generally transparent to microwave energy.

The precise location of the shielding element 212 may vary for each heating application. In general, the shielding element 212 may be positioned on the main panel 202 such that when the main panel 202 enwraps the wall W of the container C (FIG. 2C), the shielding element 212 is adjacent to (or “overlapping”) the anticipated top (i.e., uppermost or maximum) liquid level M (shown schematically with a dashed line in FIG. 2B) for the container C. In this example, although there are no exact boundaries, the construct or sheath 200 can be thought of as generally having an upper portion 224 and a lower portion 226, with the microwave energy shielding element 212 mounted to the upper portion 224. In use, the upper portion 224 of the sheath 200 generally lies adjacent to (i.e., in lateral alignment with) an uppermost portion of a liquid within the container (i.e., the top of the liquid and some quantity of liquid below the top liquid level), and the lower, unshielded portion 226 of the sheath 200 generally lies adjacent to (i.e., in lateral alignment with) a lower portion of the liquid in the container, as shown schematically in FIG. 2C.

More particularly, in this example, the shielding element 212 is positioned a distance d1 from edge 204, a distance d2 from edge 206, a distance d3 from edge 208, and a distance d4 from edge 210. In this example, d3 and d4 are approximately equal and d1 is greater than d2. However, other configurations and relationships are contemplated by the invention. For example, in each of various examples, d1 independently may be from about 0.1 to about 10 cm, from about 0.3 to about 5 cm, from about 0.5 to about 3 cm, or from about 1 to about 2.5 cm, for example, about 2.1 cm; d2 independently may be from about 1 to about 15 cm, from about 2 to about 10 cm, or from about 4 to about 8 cm, for example, about 6.3 cm; d3 independently may be from about 0.05 to about 3 cm, from about 0.1 to about 1.5 cm, or from about 0.2 to about 1 cm, for example, about 0.46 cm; and d4 independently may be from about 0.05 to about 3 cm, from about 0.1 to about 1.5 cm, or from about 0.2 to about 1 cm, for example, about 0.46 cm.

Further, in each of various examples, S1 independently may be from about 10 to about 100 cm, from about 15 to about 40 cm, or from about 20 to about 30, for example, about 27 cm; S2 independently may be from about 10 to about 100 cm, from about 20 to about 60 cm, or from about 30 to about 50, for example, about 37 cm; W1 independently may be from about 10 to about 100 cm, from about 15 to about 60 cm, or from about 20 to about 35, for example, about 26 cm; W2 independently may be from about 5 to about 60 cm, from about 10 to about 40 cm, or from about 15 to about 30, for example, about 19 cm; and L independently may be from about 40 to about 100 mm, from about 50 to about 80 mm, or from about 60 to about 70 mm, for example, about 62 mm. However, other distances, dimensions, and configurations are contemplated hereby.

Still viewing FIG. 2A, the unerected sheath 200 includes a pair of somewhat C-shaped end panels 228, 230 joined to respective edges 208, 210 of the main panel 202 along respective oblique score lines 232, 234 or other lines of disruption (e.g., fold lines) extending generally in the first direction convergently towards the longitudinal centerline CL.

Each end panel 228, 230 can be characterized as having a plurality of sections. A first section 236 extends outwardly from the main panel 202 substantially perpendicular to respective edges 208, 210, such that the first section extends obliquely with respect to the second direction D2. A second section 238 is substantially perpendicular to the respective first section 236 and extends generally in a direction oblique to the longitudinal centerline CL substantially parallel to the respective edge 208, 210 of the main panel 202. A third section 240 extends obliquely from the respective second section 238 to the main panel 202.

The blank 200 also includes a pair of locking features (e.g. tabs or projections) 242, 244 adapted to engage one another and secure the erected construct 200 to a container C, as shown in FIG. 2C. Locking projection 242 extends from the main panel 202 along edge 208 proximate the third section 240 of end panel 228 along a line of disruption 246, e.g. a score line or other type of fold line. The locking projection 242 extends substantially between and is separated from the first section 236 and the third section 240 of the end panel 228 by respective cuts or slits 248, 250. A portion of the locking projection 242 proximate to the first section 236 of the end panel 228 also is partially separated from the main panel 202 along slit 252, such that the portion of the locking projection proximate the first section 236 is free to flex and rotate in and out of the plane of the main panel 202 toward and away from the third section 240 of end panel 228, and also is able to fold and rotate toward and away from the main panel 202 along score line 246.

Locking projection 244 extends from the main panel 202 along edge 210 proximate to the first section 236 of the end panel 230 along a line of disruption 254, e.g. a score line or other type of fold line. The locking projection 244 extends substantially between and is separated from the first section 236 and the third section 240 of end panel 230 by respective cuts or slits 256, 258. A portion of the locking projection 244 proximate to the third section 240 of the end panel 230 also is partially separated from the main panel 202 along slit 260, such that the portion of the locking projection proximate to the third panel 240 is free to flex and rotate in and out of the plane of the main panel 202 toward and away from the third section 240 of end panel 230, and also is able to fold and rotate toward and away from the main panel 202 along score line 254.

To use the construct 200 according to one acceptable method, the main panel 202 may be wrapped around the wall(s) of a container C (shown with dashed lines in FIG. 2C), for example, a paper cup, and the end panels 228, 230 may be brought towards one another in a substantially contacting, facing relationship to form a handle 262. In this configuration, the upper edge of the microwave energy shielding element 212 may be substantially parallel to the uppermost edge of the wall W (or the rim R) of the container C, and the lower edge of the microwave energy shielding element 212 may be substantially parallel to the lower edge of the wall W of the container C. The uppermost portion of locking projection 242 (i.e., proximate the first section 236 of end panel 228) and the lowermost portion of locking projection 244 (i.e., proximate to the third section 240 of end panel 230) may engage the respective slits 260, 252 of the other locking projection 244, 242, such that the locking projections 242, 244 are secured to one another, as shown in FIG. 2C. In this configuration, the main panel 202 forms a frustoconical construct with opposite ends that are fully open.

When exposed to microwave energy, the upper portion of the liquid in the container C, which would otherwise be prone to overheating, is shielded from the microwave energy. As a result, the upper portion of the liquid heats at a rate slower than the lower portion of the liquid, which is exposed to microwave energy through the base of the container and through the unshielded portion of the wall and sheath. As a result, the food item has a more uniform heating profile, and in some cases, may not even need to be stirred before consumption. If desired, the handle 262 may be used to lift the container C, with the rim R of the container C preventing the container C from sliding downward as the container C is elevated. Alternatively, the construct 200 may be removed and the container may be handled in a conventional manner.

It will be understood that although particular examples of handles and locking features are illustrated schematically in FIGS. 2A-2C, numerous other handles and locking features are contemplated by the invention, and the handles and/or locking features may be omitted, for example, when the transversely opposite edges 208, 210 of the main panel 202 are attached to one another by another suitable means (e.g., using an adhesive material). Likewise, it will be understood that any of the various constructs of the invention may include other panels and features, as needed or desired for a particular heating application.

Numerous materials may be suitable for use in forming the various blanks and constructs of the invention, provided that the materials are resistant to softening, scorching, combusting, or degrading at typical microwave oven heating temperatures, for example, from about 250° F. to about 425° F. Such materials may include microwave energy interactive materials, such as those used to provide microwave energy shielding, and microwave energy transparent or inactive materials, such as those used as base materials for various constructs.

In the examples illustrated schematically in FIGS. 1A-2C, the microwave energy shielding element 110, 212 may comprise a foil or high optical density evaporated material having a thickness sufficient to reflect a substantial portion of impinging microwave energy. Typically, shielding elements are formed from a conductive, reflective metal or metal alloy, for example, aluminum, copper, or stainless steel, in the form of a solid “patch” generally having a thickness of from about 0.000285 inches to about 0.05 inches, for example, from about 0.0003 inches to about 0.03 inches. Other such elements may have a thickness of from about 0.00035 inches to about 0.020 inches, for example, 0.016 inches.

Microwave energy shielding elements may be configured in various ways, depending on the particular application for which the element is used. Larger microwave energy reflecting elements may be used where the food item is prone to scorching or drying out during heating. Smaller microwave energy reflecting elements may be used to diffuse or lessen the intensity of microwave energy. A plurality of smaller microwave energy reflecting elements also may be arranged to form a microwave energy directing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety. For instance, a container may include a microwave directing element on the base of the container, where, for example, the quantity of liquid to be heated is sufficiently large that the bottom and/or center of the liquid might otherwise be underheated relative to other portions of the food item.

Although microwave energy shielding elements are illustrated in FIGS. 1A-2C, it will be understood that other microwave energy interactive elements (not shown) may be used. For example, the construct may include a thin layer of microwave energy interactive material (generally less than about 100 angstroms in thickness, for example, from about 60 to about 100 angstroms in thickness) that tends to absorb at least a portion of impinging microwave energy and convert it to thermal energy (i.e., heat) at the interface with a food item. Such “susceptor” elements often are used to promote browning and/or crisping of the surface of a food item. When supported on a film or other substrate, such an element may be referred to as a “susceptor film” or, simply, “susceptor”.

The microwave energy interactive material of a susceptor may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

Any of the numerous microwave energy interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

If desired, the microwave energy interactive element may be supported on a microwave inactive or transparent substrate, for example, a polymer film or other suitable polymeric material, for ease of handling and/or to prevent contact between the microwave energy interactive material and the food item. Examples of polymer films that may be suitable include, but are not limited to, polyolefins, polyesters, polyamides, polyimides, polysulfones, polyether ketones, cellophanes, or any combination thereof. In one particular example, the polymer film comprises polyethylene terephthalate. The thickness of the film generally may be from about 35 gauge to about 10 mil. In each of various examples, the thickness of the film may be from about 40 to about 80 gauge, from about 45 to about 50 gauge, about 48 gauge, or any other suitable thickness. Other non-conducting substrate materials such as paper and paper laminates, metal oxides, silicates, cellulosics, or any combination thereof, also may be used.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating including circles, loops, hexagons, islands, squares, rectangles, octagons, and so forth.

Various materials may serve as the base material for the construct. For example, the construct may be formed at least partially from a polymer or polymeric material. As another example, all or a portion the apparatus may be formed from a paper or paperboard material. In one example, the paper has a basis weight of from about 15 to about 60 lbs/ream (lb/3000 sq. ft.), for example, from about 20 to about 40 lbs/ream. In another example, the paper has a basis weight of about 25 lbs/ream. In another example, the paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International.

The construct may be formed according to numerous processes known to those in the art, including using adhesive bonding, thermal bonding, ultrasonic bonding, mechanical stitching, or any other suitable process. Any of the various components used to form the apparatus may be provided as a sheet of material, a roll of material, or a die cut material in the shape of the apparatus to be formed (e.g., a blank).

It will be understood that with some combinations of elements and materials, the microwave interactive element may have a color that is visually distinguishable from the substrate or the support. However, in some instances, it may be desirable to provide a web or construct having a uniform color and/or appearance. Such a web or construct may be more aesthetically pleasing to a consumer, particularly when the consumer is accustomed to packages or containers having certain visual attributes, for example, a solid color, a particular pattern, and so on. Thus, for example, where the microwave energy interactive element is silver or grey in color, a silver or grey toned adhesive may be used to join the microwave interactive elements to the substrate, using a silver or grey toned substrate to mask the presence of the silver or grey toned microwave interactive element, using a dark toned substrate, for example, a black toned substrate, to conceal the presence of the silver or grey toned microwave interactive element, overprinting the metallized side of the web with a silver or grey toned ink to obscure the color variation, printing the non-metallized side of the web with a silver or grey ink or other concealing color in a suitable pattern or as a solid color layer to mask or conceal the presence of the microwave interactive element, or any other suitable technique or combination thereof.

The present invention may be understood further by way of the following examples, which are not to be construed as limiting in any manner.

### EXAMPLES

Various cups of coffee were heated in different microwave ovens for different lengths of time and with different degrees of shielding according to the invention. A 12 oz. paperboard cup containing about 284 g of Starbuck's “Muldoon's Own Light Roast” coffee was used to conduct the evaluations. The height of the cup was 11 cm and the diameter of the opening at the top of the cup was about 8.8 cm. Temperatures were measured immediately before heating, immediately after heating, and one minute after heating. Temperatures were measured at the top of the beverage, at the middle of the beverage, and at the bottom of the beverage, generally along a central vertical axis and along the edge of the cup. The starting temperature of each coffee sample was about 66° F., except as otherwise indicated.

### Example 1

Baseline heating characteristics at the center of the coffee were determined according to the procedure described above. The results are presented in Table 1.

TABLE 1
Temperature at center of coffee, no shielding

| | Time (s) | Bottom (° F.) | Middle (° F.) | Top (° F.) |
|---|---|---|---|---|
| 900 W Oven A | 120 | 124 | 130 | 146 |
| 1000 W Oven B | 90 | 138 | 144 | 163 |
| 1100 W Oven C | 75 | 139 | 146 | 160 |

### Example 2

The heating characteristics at the center of the coffee were determined according to the procedure described above using a cup with a 3 cm shielding ring 2.1 cm from the top edge of the cup. The results are presented in Table 2.

TABLE 2
Temperature at center of coffee, 3 cm shield

| | Time (s) | Bottom (° F.) | Middle (° F.) | Top (° F.) |
|---|---|---|---|---|
| 900 W Oven A | 120 | 123 | 125 | 131 |
| 1000 W Oven B | 90 | 135 | 135 | 136 |
| 1100 W Oven C | 75 | 146 | 148 | 149 |

### Example 3

Baseline heating characteristics at the edge of the coffee were determined according to the procedure described above. The results are presented in Table 3.

TABLE 3
Temperature at edge of coffee, no shielding

| | Time (s) | Bottom (° F.) | Middle (° F.) | Top (° F.) |
|---|---|---|---|---|
| 900 W Oven A | 120 | 126 | 131 | 147 |
| 1000 W Oven B | 90 | 139 | 145 | 164 |
| 1100 W Oven C | 75 | 140 | 145 | 160 |

### Example 4

The heating characteristics at the edge of the coffee were determined according to the procedure described above using a cup with a 3 cm shielding ring 2.1 cm from the top edge of the cup. The results are presented in Table 4.

TABLE 4
Temperature at edge of coffee, 3 cm shield

| | Time (s) | Bottom (° F.) | Middle (° F.) | Top (° F.) |
|---|---|---|---|---|
| 900 W Oven A | 120 | 123 | 125 | 132 |
| 1000 W Oven B | 90 | 134 | 135 | 135 |
| 1100 W Oven C | 75 | 146 | 149 | 150 |

### Example 5

The heating characteristics at the center and at the edge of the coffee were determined according to the procedure described above using a cup with a 2.5 cm shielding ring 2.1 cm from the top edge of the cup and a 3.5 cm shielding ring 2.1 cm from the top edge of the cup. The coffee samples were heated for about 90 seconds in an 1100 W Sharp microwave oven. The results are presented in Tables 5 and 6 with the results from the previous evaluations.

TABLE 5
Temperature at center of coffee, various shields

| Shield | Time (s) | Bottom (° F.) | Middle (° F.) | Top (° F.) |
|---|---|---|---|---|
| 0 cm | 90 | 138 | 144 | 163 |
| 2.5 cm | 90 | 144 | 145 | 145 |
| 3.0 cm | 90 | 135 | 135 | 136 |
| 3.5 cm | 90 | 139 | 140 | 140 |

TABLE 6
Temperature at edge of coffee, various shields

| Shield | Time (s) | Bottom (° F.) | Middle (° F.) | Top (° F.) |
|---|---|---|---|---|
| 0 cm | 90 | 139 | 145 | 164 |
| 2.5 cm | 90 | 144 | 144 | 145 |
| 3.0 cm | 90 | 134 | 135 | 135 |
| 3.5 cm | 90 | 138 | 140 | 140 |

The various temperatures were measured again after about 1 minute. The results are presented in Tables 7 and 8.

TABLE 7
Temperature at center of coffee after 1 minute, various shields

| Shield | Bottom (° F.) | Middle (° F.) | Top (° F.) |
|---|---|---|---|
| 0 cm | 139 | 143 | 159 |
| 2.5 cm | 143 | 143 | 143 |
| 3.0 cm | 134 | 134 | 134 |
| 3.5 cm | 138 | 139 | 139 |

TABLE 8
Temperature at edge of coffee after 1 minute, various shields

| Shield | Bottom (° F.) | Middle (° F.) | Top (° F.) |
|---|---|---|---|
| 0 cm | 139 | 144 | 158 |
| 2.5 cm | 142 | 143 | 144 |
| 3.0 cm | 133 | 133 | 134 |
| 3.5 cm | 137 | 137 | 138 |

Table 9 summarizes the results of Examples 1-5 and other testing conducted.

TABLE 9
Data from Examples 1-5 plus additional evaluations*

| | | | | | IMMEDIATE TEMPERATURES | | | | | | 1 MINUTE STANDING TIME TEMPERATURES | | | | | |
|---|---|---|---|---|---|---|---|---|---|---|---|---|---|---|---|---|
| | Initial | | | Time | CENTER | | | EDGE | | | CENTER | | | EDGE | | |
| Test | Temp (F.) | Shield | Oven | (s) | Bottom | Middle | Top | Bottom | Middle | Top | Bottom | Middle | Top | Bottom | Middle | Top |
| 1 | 66 | none | B | 90 | 138 | 144 | 163 | 139 | 145 | 164 | 139 | 143 | 159 | 139 | 144 | 158 |
| 2 | 66 | none | B | 120 | 161 | 166 | 188 | 161 | 166 | 189 | 160 | 165 | 184 | 160 | 165 | 184 |
| 3 | 66 | 2.5 cm | B | 90 | 144 | 145 | 145 | 144 | 144 | 145 | 143 | 143 | 143 | 142 | 143 | 144 |
| 4 | 66 | 3 cm | B | 90 | 135 | 135 | 136 | 134 | 135 | 135 | 134 | 134 | 134 | 133 | 133 | 134 |
| 5 | 66 | 3.5 cm | B | 90 | 139 | 140 | 140 | 138 | 140 | 140 | 138 | 139 | 139 | 137 | 137 | 138 |
| 6 | 76 | none | C | 105 | 152 | 157 | 172 | 153 | 157 | 173 | 150 | 155 | 168 | 150 | 156 | 167 |
| 7 | 66 | none | C | 75 | 139 | 146 | 160 | 140 | 145 | 160 | 138 | 144 | 157 | 139 | 143 | 157 |
| 8 | 66 | 3 cm | C | 75 | 146 | 148 | 149 | 146 | 149 | 150 | 145 | 147 | 148 | 146 | 148 | 149 |
| 9 | 66 | none | A | 90 | 123 | 127 | 143 | 124 | 128 | 143 | 121 | 127 | 139 | 122 | 128 | 141 |
| 10 | 66 | none | A | 105 | 124 | 130 | 147 | 127 | 130 | 146 | 125 | 130 | 145 | 126 | 130 | 144 |
| 11 | 66 | none | A | 120 | 124 | 130 | 146 | 126 | 131 | 147 | 125 | 130 | 145 | 125 | 129 | 143 |
| 12 | 66 | 3 cm | A | 120 | 123 | 125 | 131 | 123 | 125 | 132 | 122 | 124 | 129 | 123 | 125 | 130 |

*All evaluations conducted using Muldoon's Own Light Roast, Initial weight = 284 g, 12 oz. paperboard cup

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A method of promoting uniform heating of a liquid in a microwave oven, comprising:
providing a container, the container including a base and an upstanding wall that define an interior space for receiving a liquid, the liquid within the interior space having an uppermost portion and a lowermost portion, the uppermost portion of liquid being prone to overheating relative to the lowermost portion;
providing a microwave energy shielding element for being substantially laterally aligned with the uppermost portion of liquid; and
exposing the liquid in the container to microwave energy, whereby the microwave energy shielding element reduces the transmission of microwave energy to the uppermost portion of liquid in the container.

2. The method of claim 1, wherein reducing the transmission of microwave energy to the uppermost portion of liquid substantially mitigates the overheating of the uppermost portion of liquid relative to the lowermost portion of liquid.

3. The method of claim 1, wherein providing the microwave energy shielding element comprises
determining an anticipated top liquid level for the container, and
joining the microwave energy shielding element to the wall of the container such that the microwave energy shielding element substantially overlaps the anticipated top liquid level.

4. The method of claim 3, wherein
the microwave energy shielding element includes a pair of opposite ends, and
joining the microwave energy shielding element to the container comprises positioning the microwave energy shielding element such that the ends are spaced from one another in a non-overlapping relationship.

5. The method of claim 4, wherein the ends have a curvilinear shape.

6. The method of claim 3, wherein providing the microwave energy shielding element comprises
determining an anticipated top liquid level for the container,
mounting the microwave energy shielding element to a sheath for enwrapping the container, the microwave energy shielding element being mounted on the sheath such that the microwave energy shielding element substantially overlaps the anticipated top liquid level of the container, and
enwrapping the container with the sheath.

7. The method of claim 6, wherein
the sheath includes a main panel and a pair of end panels, and
enwrapping the container with the sheath comprises wrapping the main panel around the wall of the container and bringing the end panels into a facing relationship with one another.

8. The method of claim 7, further comprising using the end panels in a facing relationship with one another as a handle for lifting the container.

9. The method of claim 7, wherein
the sheath includes a pair of locking projections adapted to engage one another, and
enwrapping the container with the sheath further comprises engaging the locking projections.

10. A container for providing even heating of a liquid food item in a microwave oven, comprising:
a container including a base and an upstanding wall that define an interior space for receiving a liquid, the liquid within the interior space having an uppermost portion adjacent to an upper portion of the wall and a lowermost portion adjacent to a lower portion of the wall, the lower portion of the wall being at least partially transparent to microwave energy; and
a microwave energy shielding element overlying the upper portion of the wall, the microwave energy shielding element being operative for reducing the transmission of microwave energy to the uppermost portion of liquid in the container.

11. The container of claim 10, wherein
the wall includes an uppermost edge defining an opening, and
the shielding element is spaced from the uppermost edge of the wall.

12. The container of claim 10, wherein the microwave energy shielding element includes an upper edge, a lower edge, and a pair of lateral ends.

13. The container of claim 12, wherein the lateral ends have a rounded shape.

14. The container of claim 12, wherein the lateral ends are spaced from one another.

15. The container of claim 10, further comprising an aperture circumscribed by the microwave energy shielding element.

16. A construct for providing even heating of a liquid food item in a microwave oven, comprising:
a main panel for enwrapping a wall of container, the container for receiving a liquid up to an anticipated top liquid level for the container;
a microwave energy shielding element mounted to the main panel, the microwave energy shielding element being positioned such that the microwave energy shielding element overlaps with the anticipated top level of the liquid when the main panel is enwrapping the container; and
a pair of locking projections connected to the main panel, the locking projections being adapted to engage one another.

17. The construct of claim 16, wherein the locking projections engaged with one another maintain the main panel in a proximate relationship with the wall of the container.

18. The construct of claim 16, further comprising a pair of end panels connected to the main panel, the end panels being adapted to be brought into a substantially facing relationship with one another when the locking projections are engaged with one another.

19. The construct of claim 18, wherein the end panels are substantially C-shaped.

20. The construct of claim 16, in combination with the container, wherein the microwave energy shielding element has an upper edge substantially parallel to an upper edge of the wall of the container and a lower edge substantially parallel to a lower edge of the wall of the container.

21. A construct consisting essentially of:
a panel having a curved trapezoidal shape defined partially by a first arcuate edge and a second arcuate edge, the panel being substantially transparent to microwave energy; and
a microwave energy shielding element mounted to the panel, the microwave energy shielding element including a first edge substantially equidistant from the first edge of the main panel, and a second edge substantially equidistant from the second edge of the main panel.
